(19) United States
(12) Patent Application Publication
(10) Pub. No.: US 2009/0180576 A1
(43) Pub. Date: Jul. 16, 2009

(54) Amplitude modulation decoder

(75) Inventor: James Lorin Rulla, Gresham, OR (US)

Correspondence Address: DOCKET CLERK, P.O. DRAWER 800889, DALLAS, TX, 75380, US

(73) Assignee: Rim Semiconductor Company, Portland, OR (US)

(21) Appl. No.: 12/157,935

(22) Filed: Jun. 13, 2008

Related U.S. Application Data
(60) Provisional application No. 60/934,850, filed on Jun. 15, 2007.

(51) Int. Cl. H04L 27/06

(52) U.S. Cl. 375/320

(57) ABSTRACT

Embodiments of the present disclosure provide improved techniques for decoding amplitude modulated messages, including those encoded using quadrature amplitude modulation (QAM). For example, a method of decoding amplitude modulation (AM)-encoded messages includes generating a received waveform matrix from a series of receive basis pulses, receiving a multi-dimensional waveform having n AM-encoded messages. The method also includes removing inter-symbol interference from the waveform. In addition, the method includes applying an error-minimizing technique to the received waveform matrix to decode the n AM-encoded messages.

### CROSS-REFERENCE TO RELATED APPLICATION

This application claims priority under 35 USC 119(e) to U.S. provisional Application Ser. No. 60/934,850, filed on Jun. 15, 2007, and which is incorporated herein by reference.

### TECHNICAL FIELD

This disclosure relates generally to decoding amplitude-modulated signals, and in particular to decoding signals encoded using quadrature amplitude modulation (QAM).

### BACKGROUND

Amplitude modulation conveys data by modulating the amplitude of certain carrier waves. Linear amplitude modulation schemes (including Quadrature Amplitude Modulation (QAM)) encode messages as linear combinations of certain basis pulses. The resulting linear combinations are sent from a transmitter to a receiver via a communication line. The communication line typically distorts the waveform. The receiver analyzes the received waveform to deduce the messages sent by the transmitter.

Conventional carrier waves are sinusoidal and conventional basis pulses are sinusoids of short duration. Conventional QAM modulates the amplitude of two basis pulses per carrier. These basis pulse pairs are, conventionally, two sinusoidal waves of the same frequency but typically out of phase with respect to each other by 90 degrees.

### SUMMARY

Embodiments of the present disclosure provide improved techniques for decoding signals originally encoded using quadrature amplitude modulation (QAM).

In a first embodiment, a method of decoding amplitude modulation (AM)-encoded messages includes generating a received waveform matrix from a series of receive basis pulses, receiving a multi-dimensional waveform having n AM-encoded messages, removing inter-symbol interference from the waveform, and applying an error-minimizing technique to the received waveform matrix to decode the n AM-encoded messages.

In particular embodiments, amplitude modulation comprises quadrature amplitude modulation (QAM).

In other particular embodiments, removing the inter-symbol interference from the waveform produces tail-less messages.

In yet other particular embodiments, the error-minimizing technique comprises a least-squares technique.

In still other particular embodiments, decoding of messages occurs before the entire waveform is received.

In additional particular embodiments, two or more transmit basis pulse of the waveform are pre-emphasized.

In other particular embodiments, two or more transmit basis pulse of the waveform are pre-emphasized using the following relationship: C=BR⁻¹, wherein B denotes the original basis pulse, C denotes the transmit basis pulse, and R denotes upper triangular.

In yet other particular embodiments, two or more transmit basis pulse of the waveform are pre-emphasized using a QR factorization or a singular value decomposition (SVD).

In still other particular embodiments, two or more transmit basis pulse of the waveform are pre-emphasized using the following relationship: C=BQ₂D^{†}, wherein B denotes the original basis pulse, C denotes the transmit basis pulse, D^{†} denotes the pseudo-inverse of diagonal D, and Q₂ denotes orthogonal.

In a second embodiment, a receiver for decoding amplitude modulation (AM)-encoded messages includes an input for receiving a multi-dimensional waveform having n AM-encoded messages and a decoder for removing inter-symbol interference from the waveform. The decoder applies an error-minimizing technique to a received waveform matrix to decode the n messages after removing inter-symbol interference from the waveform, the receive waveform matrix is generated from a series of receive basis pulses during a training phase.

In a third embodiment, a method of decoding amplitude modulation (AM)-encoded messages include receiving a series of basis pulses from a transmitter, transmitting a pre-emphasis matrix based on the series of basis pulses to the transmitter, and receiving, from the transmitter, a multi-dimensional waveform having n AM-encoded messages. Two or more basis pulse of the waveform are pre-emphasized using the transmitted matrix. In addition, the method includes removing inter-symbol interference from the waveform and using an error-minimizing technique to decode the n AM-encoded messages after removing inter-symbol interference from the waveform.

Solution operators for the least-squares method provide a method of pre-emphasizing the transmit basis pulses. The resulting transmit basis pulses need not be sinusoidal, they need not be orthogonal, and the receiver need have no knowledge of them. The receiver makes no effort, via an inverse filter or otherwise, to recover the transmit basis pulses.

Other technical features may be readily apparent to one skilled in the art from the following figures, descriptions and claims.

### BRIEF DESCRIPTION OF THE DRAWINGS

For a more complete understanding of this disclosure and its features, reference is now made to the following description, taken in conjunction with the accompanying drawings, in which:

FIG. 1A is a diagram of a transmitter-receiver system according to one embodiment of the present disclosure;

FIG. 1B is a diagram of a wireless transmitter-receiver system according to one embodiment of the present disclosure;

FIG. 2 is a flowchart of a method of decoding amplitude modulated (AM) messages according to one embodiment of the present disclosure; and

FIG. 3 is a diagram of a digital subscriber line (DSL) modem using a QAM decoder in accordance with one embodiment of the present disclosure.

FIG. 4 is a flowchart of a method of pre-emphasizing the receive basis pulses of a multi-dimensional waveform.

### DETAILED DESCRIPTION

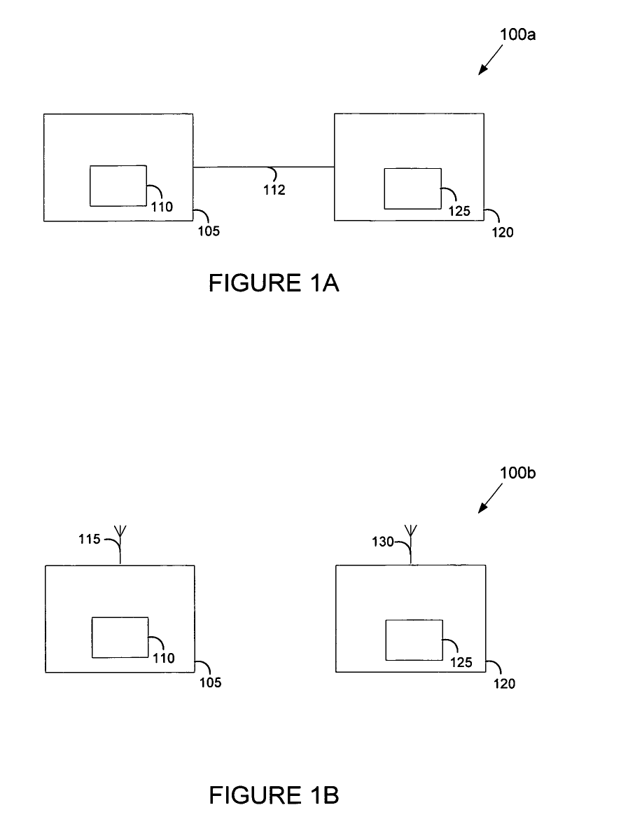

Embodiments of the present disclosure provide improved techniques for decoding messages encoded with amplitude modulation, including quadrature amplitude modulation (QAM). The techniques could be used in any suitable system such as, for example, systems 100a and 100b shown in FIGS. 1A and 1B, respectively.

System 100a, shown in FIG. 1A, includes a transmitter 105 and an encoder 110. A wireline connection 112 connects transmitter 105 to receiver 120. Receiver 120 includes a decoder 125. Similarly, system 100b, shown in FIG. 1B, includes the transmitter 105, the encoder 110, and an antenna 115. System 100b includes the receiver 120, the decoder 125 and an antenna 130.

In exemplary systems 100a and 100b, transmitter 105 transmits an encoded messages to receiver 120. Receiver 120 receives a waveform w and attempts to decode the received waveform in decoder 125.

In one embodiment, decoder 125 uses decoding techniques using an error-minimizing technique such as the method of least-squares to decode the messages xⁱ from the received waveform w.

In another embodiment, other error-minimizing techniques could also be used such as, for example, techniques that do not use square norms or others that use weighted square norms.

Developing a Mathematical Relationship Using Basis Pulses

The systems of the present disclosure model linear amplitude modulation in the form of mathematical relationships, suppose there are n discrete basis pulses {b¹, . . . , bⁿ}, each of duration m, as shown by the relationship in Equation 1 below:

$$Transmitted basis pulse j = {b}^{j} = [ \begin{matrix}{b}_{1}^{j} \\ {b}_{2}^{j} \\ ⋮ \\ {b}_{m}^{j} \\ 0 \\ 0 \\ ⋮\end{matrix} ] \begin{matrix}T \\ i \\ m \\ e \\ ↓\end{matrix} . \qquad ( Eqn . 1 )$$

If {x₁, . . . , xₙ} are n messages (numbers) to be encoded, then the resulting waveform is shown by the relationship in Equation 2 below:

$$\begin{matrix}Transmitted waveform = {b}^{1} {x}^{1} + {b}^{2} {x}^{2} + … + {b}^{n} {x}^{n} \\ = [ \begin{matrix}{b}_{1}^{1} & {b}_{1}^{2} & … & {b}_{1}^{n} \\ {b}_{2}^{1} & {b}_{2}^{2} & … & {b}_{2}^{n} \\ ⋮ & ⋮ & … & ⋮ \\ {b}_{m}^{1} & {b}_{m}^{2} & … & {b}_{m}^{n} \\ 0 & 0 & … & 0 \\ ⋮ & ⋮ & … & ⋮\end{matrix} ] [ \begin{matrix}{x}_{1} \\ {x}_{2} \\ ⋮ \\ {x}_{n}\end{matrix} ] \\ = Bx .\end{matrix} \qquad ( Eqn . 2 )$$

In Equation 2, column j of matrix B is the basis pulse b^{j}.

Communication lines typically delay and stretch a signal in time. For example, if the transmitter sends a basis pulse b^{j}, the receiver gets the received basis pulse j as shown by the relationship in Equation 3 below:

$$Received basis pulse j = [ \begin{matrix}0 \\ ⋮ \\ 0 \\ {a}_{1}^{j} \\ {a}_{2}^{j} \\ ⋮ \\ {a}_{m}^{j} \\ {t}_{1}^{j} \\ {t}_{2}^{j} \\ ⋮\end{matrix} ] \begin{matrix}T \\ i \\ m \\ e \\ ↓\end{matrix} . \qquad ( Eqn . 3 )$$

The zeros in Equation 3 denote the time delay of the transmission. The relationship shown by Equation 3 emphasizes that the received basis pulse j is described in terms of a symbol-length vector a^{j} (with components aᵢ^{j}, i=1, . . . , m), called the receive basis pulse, followed by a tail T^{j} (with components tᵢ^{j}, i=1, 2, . . . ). The tail may be considerably longer than the receive basis pulse.

The modulators of the present disclosure send transmit basis pulses to the receiver during a training phase before sending any messages. Such modulators may send the pulses repeatedly with long pauses between the pulses. This allows the receiver to identify and store the receive basis pulses and their tails during the training period. The receiver also identifies the time delay during the training period. Since the receiver compensates for the time delay and since the leading zeros (e.g., Equation 3) are a distraction, the rows of zeros are omitted in the discussion herein. In other words, omitting the rows of zeros simplifies the relationship by omitting the time delay.

Linear amplitude modulation assumes the communication line acts as a linear operator, so the transmitted waveform of Equation 2 is received as shown in the relationship found in Equation 4 below:

$$\begin{matrix}Received waveform = [ \begin{matrix}{a}_{1}^{1} \\ {a}_{2}^{1} \\ ⋮ \\ {a}_{m}^{1} \\ {t}_{1}^{1} \\ {t}_{2}^{1} \\ ⋮\end{matrix} ] {x}_{1} + [ \begin{matrix}{a}_{1}^{2} \\ {a}_{2}^{2} \\ ⋮ \\ {a}_{m}^{2} \\ {t}_{1}^{2} \\ {t}_{2}^{2} \\ ⋮\end{matrix} ] {x}_{2} + … + [ \begin{matrix}{a}_{1}^{n} \\ {a}_{2}^{n} \\ ⋮ \\ {a}_{m}^{n} \\ {t}_{1}^{n} \\ {t}_{2}^{n} \\ ⋮\end{matrix} ] {x}_{n} \\ = [ \begin{matrix}{a}_{1}^{1} & {a}_{1}^{2} & … & {a}_{1}^{n} \\ {a}_{2}^{1} & {a}_{2}^{2} & … & {a}_{2}^{n} \\ ⋮ & ⋮ & … & ⋮ \\ {a}_{m}^{1} & {a}_{m}^{2} & … & {a}_{m}^{n} \\ {t}_{1}^{1} & {t}_{1}^{2} & … & {t}_{1}^{n} \\ {t}_{2}^{1} & {t}_{2}^{2} & … & {t}_{2}^{n} \\ ⋮ & ⋮ & … & ⋮\end{matrix} ] [ \begin{matrix}{x}_{1} \\ {x}_{2} \\ ⋮ \\ {x}_{n}\end{matrix} ] .\end{matrix} \qquad ( Eqn . 4 )$$

The relationship found in Equation 4 can be represented in block form as shown in the relationship found in Equation 5 below:

$$[ \begin{matrix}\underline{\begin{matrix}{a}_{1}^{1} & {a}_{1}^{2} & … & {a}_{1}^{n} \\ {a}_{2}^{1} & {a}_{2}^{2} & … & {a}_{2}^{n} \\ ⋮ & ⋮ & … & ⋮ \\ {a}_{m}^{1} & {a}_{m}^{2} & … & {a}_{m}^{n}\end{matrix}} \\ \underline{\begin{matrix}{t}_{1}^{1} & {t}_{1}^{2} & … & {t}_{1}^{n} \\ {t}_{2}^{1} & {t}_{2}^{2} & … & {t}_{2}^{n} \\ ⋮ & ⋮ & … & ⋮ \\ {t}_{m}^{1} & {t}_{m}^{2} & … & {t}_{m}^{n}\end{matrix}} \\ \underline{\begin{matrix}{t}_{m + 1}^{1} & {t}_{m + 1}^{2} & … & {t}_{m + 1}^{n} \\ {t}_{m + 2}^{1} & {t}_{m + 2}^{2} & … & {t}_{m + 2}^{n} \\ ⋮ & ⋮ & … & ⋮ \\ {t}_{2 m}^{1} & {t}_{2 m}^{2} & … & {t}_{2 m}^{n}\end{matrix}} \\ \begin{matrix}{t}_{2 m + 1}^{1} & {t}_{2 m + 1}^{2} & … & {t}_{2 m + 1}^{n} \\ {t}_{2 m + 2}^{1} & {t}_{2 m + 2}^{2} & … & {t}_{2 m + 2}^{n} \\ ⋮ & ⋮ & … & ⋮\end{matrix}\end{matrix} ] [ \begin{matrix}{x}_{1} \\ {x}_{2} \\ ⋮ \\ {x}_{n}\end{matrix} ] = [ \begin{matrix}A \\ {T}^{1} \\ {T}^{2} \\ {T}^{3} \\ ⋮\end{matrix} ] [ \begin{matrix}{x}_{1} \\ {x}_{2} \\ ⋮ \\ {x}_{n}\end{matrix} ] . \qquad ( Eqn . 5 )$$

Each block in the matrices shown in Equation 5 above has m rows (i.e., m is the symbol length). Then, except for accounting for the time delay, the received waveform of Equation 4 is shown by the relationship found in Equation 6 below:

$$Received waveform = [ \begin{matrix}A \\ {T}^{1} \\ {T}^{2} \\ {T}^{3} \\ ⋮\end{matrix} ] [ \begin{matrix}{x}_{1} \\ {x}_{2} \\ ⋮ \\ {x}_{n}\end{matrix} ] = [ \begin{matrix}A \\ {T}^{1} \\ {T}^{2} \\ {T}^{3} \\ ⋮\end{matrix} ] {x}^{1} . \qquad ( Eqn . 6 )$$

In Equation 6, x¹ is the vector whose components are the messages x₁, x₂, . . . , xₙ.

The transmitter sends many messages by sending many vectors of messages sequentially. If xⁱ is the ith vector of the message to be transmitted (i.e., xⁱ has components x₁ⁱ, . . . , xₙⁱ), then the transmitted waveform matrix is shown by the relationship in Equation 7 below:

$$\begin{matrix}Transmitted waveform matrix = [ \begin{matrix}{Bx}^{1} \\ {Bx}^{2} \\ {Bx}^{3} \\ ⋮\end{matrix} ] \\ = [ \begin{matrix}B & O & O & … \\ O & B & O & … \\ O & O & B & … \\ ⋮ & ⋮ & ⋮ & ⋱\end{matrix} ] [ \begin{matrix}{x}^{1} \\ {x}^{2} \\ {x}^{3} \\ ⋮\end{matrix} ] .\end{matrix} \qquad ( Eqn . 7 )$$

In Equation 7, “O” denotes the m×n zero matrix.

Communication lines are stationary. As a result of the training process, a received waveform matrix is generated to represent the received waveform s as shown in Equation 8 below, omitting the time delay.

$$\begin{matrix}Received waveform matrix = [ \begin{matrix}A & O & O & … \\ {T}^{1} & A & O & … \\ {T}^{2} & {T}^{1} & A & … \\ ⋮ & ⋮ & ⋮ & ⋱\end{matrix} ] [ \begin{matrix}{x}^{1} \\ {x}^{2} \\ {x}^{3} \\ ⋮\end{matrix} ] \\ = [ \begin{matrix}{s}^{1} \\ {s}^{2} \\ {s}^{3} \\ ⋮\end{matrix} ] \\ = s .\end{matrix} \qquad ( Eqn . 8 )$$

Note that the j^{th} symbol s^{j} of the received waveform matrix depends on the message x^{j} (through the matrix A) and on all previous messages x^{j-i} (through the tails Tⁱ of the received basis pulses). The tail contribution is called inter-symbol interference. The tail contribution of the message x^{j} is removed by using information obtained from the previous messages x^{j-1}.

The amplitude modulation decoders of the present disclosure recover the messages xⁱ from the received waveform s. In other words, given a received waveform s, the decoders of the present disclosure decode the vectors of messages xⁱ using Equation 8 above.

However, the discussion thus far assumes the communication line is noise-free. In actuality, physical communication lines add noise to the transmitted waveform. If n represents the noise and s is the waveform received on a noiseless line, then the receiver actually receives the waveform w resulting in the relationship shown by Equation 9 below:

Received waveform with noise=s+n=w. (Eqn. 9)

Accordingly, the decoders of the present disclosure decode the messages x using the received matrix waveform generated during training as shown in the relationship found in Equation 10 below:

$$[ \begin{matrix}A & O & O & … \\ {T}^{1} & A & O & … \\ {T}^{2} & {T}^{1} & A & … \\ ⋮ & ⋮ & ⋮ & ⋱\end{matrix} ] [ \begin{matrix}{x}^{1} \\ {x}^{2} \\ {x}^{3} \\ ⋮\end{matrix} ] = [ \begin{matrix}{w}^{1} \\ {w}^{2} \\ {w}^{3} \\ ⋮\end{matrix} ] = w . \qquad ( Eqn . 10 )$$

Full Waveform Implementation

In one implemention, the receiver 120 may wait for the entire receive waveform w to arrive, then solve Equation 10 by least-squares (or some other error-minimizing technique). The least-squares solution {\hat{x}¹,\hat{x}², . . . } is the collection of messages which minimizes the square distance shown in Equation 11 below:

$${‖ [ \begin{matrix}A & O & O & … \\ {T}^{1} & A & O & … \\ {T}^{2} & {T}^{1} & A & … \\ ⋮ & ⋮ & ⋮ & ⋱\end{matrix} ] [ \begin{matrix}{x}^{1} \\ {x}^{2} \\ {x}^{3} \\ ⋮\end{matrix} ] - [ \begin{matrix}{w}^{1} \\ {w}^{2} \\ {w}^{3} \\ ⋮\end{matrix} ] ‖}^{2} . \qquad ( Eqn . 11 )$$

The square norm, ∥y∥², in Equation 11 is the sum of the squares of the components of the vector y as shown by the relationship found in Equation 12 below:

$${‖ [ \begin{matrix}{y}_{1} \\ {y}_{2} \\ {y}_{3} \\ ⋮\end{matrix} ] ‖}^{2} = {y}_{1}^{2} + {y}_{2}^{2} + … . \qquad ( Eqn . 12 )$$

The least-squares solution {\hat{x}¹, \hat{x}² . . . } minimizing the error expressed in Equation 11 is the solution to the normal equations as shown by the relationship in Equation 13 below:

$$[ \begin{matrix}{A}^{T} & {( {T}^{1} )}^{T} & {( {T}^{2} )}^{T} & … \\ {O}^{T} & {A}^{T} & {( {T}^{1} )}^{T} & … \\ {O}^{T} & {O}^{T} & {A}^{T} & … \\ ⋮ & ⋮ & ⋮ & ⋱\end{matrix} ] ⌊ \begin{matrix}A & O & O & … \\ {T}^{1} & A & O & … \\ {T}^{2} & {T}^{1} & A & … \\ ⋮ & ⋮ & ⋮ & ⋱\end{matrix} ⌋ [ \begin{matrix}{x}^{1} \\ {x}^{2} \\ {x}^{3} \\ ⋮\end{matrix} ] = [ \begin{matrix}{A}^{T} & {( {T}^{1} )}^{T} & {( {T}^{2} )}^{T} & … \\ {O}^{T} & {A}^{T} & {( {T}^{1} )}^{T} & … \\ {O}^{T} & {O}^{T} & {A}^{T} & … \\ ⋮ & ⋮ & ⋮ & ⋱\end{matrix} ] [ \begin{matrix}{w}^{1} \\ {w}^{2} \\ {w}^{3} \\ ⋮\end{matrix} ] . \qquad ( Eqn . 13 )$$

Other embodiments of the present disclosure could use other error-minimizing techniques in lieu of ∥y∥² defined in Equation 11 above. For example, in one embodiment, the present disclosure could use the lₚ norms defined for p≧1 by Equation 14a below:

$${‖ ( \begin{matrix}{y}_{1} \\ {y}_{2} \\ {y}_{3} \\ ⋮\end{matrix} ) ‖}_{{l}_{p}}^{p} = {\vert {y}_{1} \vert}^{p} + {\vert {y}_{2} \vert}^{p} + {\vert {y}_{3} \vert}^{p} + … . \qquad ( Eqn . 14 a )$$

As another example, the present disclosure could use l_{∞} norm defined by Equation 14b below:

$$‖ ( \begin{matrix}{y}_{1} \\ {y}_{2} \\ {y}_{3} \\ ⋮\end{matrix} ) ‖ = max ( \vert {y}_{1} \vert , \vert {y}_{2} \vert , \vert {y}_{3} \vert , … ) . \qquad ( Eqn . 14 b )$$

The relationship found in Equations 14a and 14b can be used in Equation 11 above in place of the square norm in accordance with the present disclosure. Minimizing the error defined by these norms requires solving non-linear equations (except in the case of the l₂ norm, which is equivalent to the square norm of Equation 13 above).

It should be understood that other embodiments of the present disclosure use weighted measures of error. It should also be understood that still other measures of error which do not arise from norms and are in accordance with other principles associated with optimization and convex analysis could also be used.

Single Symbol Implementation

In another implementation, the receiver 120 may decode each message after it has received enough data to analyze the waveform. For example, suppose the receiver 120 has already decoded messages x¹, . . . , x^{j-1} and has received the receive waveform up through symbol w^{j}. Then “row” j of Equation 10 is given by the relationship found in Equation 15 below:

. . . +T²x^{j-2}+T¹x^{j-1}+Ax^{j}=w^{j}. (Eqn. 15)

Since the messages x¹, . . . , x^{j-1} have been decoded already, it is possible to decode the j^{th} message x^{j} by using Equation 16 below:

Ax^{j}=w^{j}=−T¹x^{j-1}−T²x^{j-2}− . . . =\tilde{w}^{j}. (Eqn. 16)

In other words, an error-minimizing solution could be found such as the least squares solution, or another solution which is most appropriate for decoding the message in some sense.

The term Tⁱx^{j-i} in Equation 16 is the inter-symbol interference in symbol j due to symbol j−i. Since inter-symbol interference arises from the tails of the received basis pulses, \tilde{w}^{j} could be referred to as a “tailless” received waveform.

The least squares solution \hat{x}^{j} to Equation 16 is the solution to the normal equations as shown in the relationship given by Equation 17 below:

A^{T}Ax^{j}=A^{T}(w^{j}−T¹x^{j-1}−T²x^{j-2}− . . . )=A^{T}\tilde{w}^{j}. (Eqn. 17)

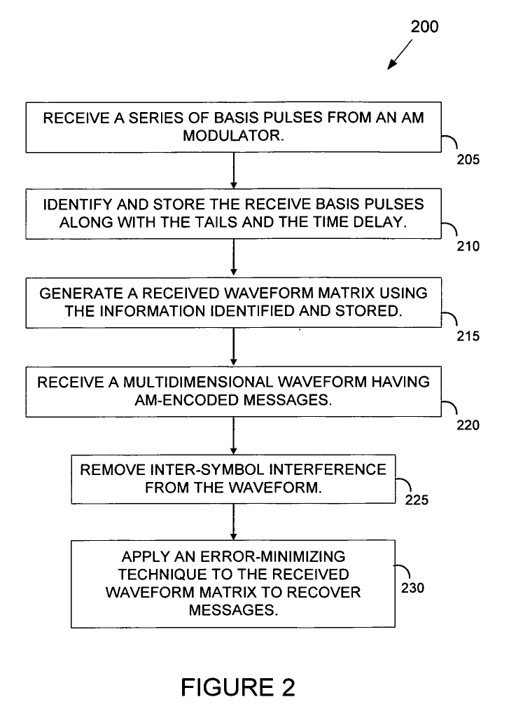

Accordingly, in one embodiment, the present disclosure provides, for example, method 200 (shown in FIG. 2). In step 205, a receiver receives a series of basis pulses from an AM modulator during a training session. The receiver then identifies and stores the receive basis pulses along with the tails in step 210. The receiver also identifies the time delay during this step. In step 215, the receiver generates a received waveform matrix using the information identified and stored during the training session. After receiving a multi-dimensional waveform having AM-encoded messages in step 220, the receiver removes the tails of the previous messages from w^{j} (i.e., removes an inter-symbol interference from the waveform) in step 225. The receiver may remove the tail of a message, for example, by using information obtained from previous messages. The receiver solves for the most appropriate message by applying an error-minimizing technique to the received waveform matrix in step 230. The error-minimizing technique may be, for example, a least-squares technique.

Double Symbol Implementation

In still another embodiment, the receiver 120 could wait to receive waveform symbol w^{j+1} (or at least the first n components of w^{j+1}) before solving for message x^{j}. In this example, using blocks j and j+1 in Equation 10, the relationship shown in Equation 18 results:

. . . +T²x^{j-2}+T¹x^{j-1}+Ax^{j}=w^{j}

. . . +T²x^{j-1}+T¹x^{j}+Ax^{j+1}=w^{j+1}. (Eqn. 18)

Removing the tails of previously decoded messages in Equation 18 results in the relationship shown in Equation 19 below:

$$⌊ \begin{matrix}A & O \\ {T}^{1} & A\end{matrix} ⌋ ⌊ \begin{matrix}{x}^{j} \\ {x}^{j + 1}\end{matrix} ⌋ = ⌊ \begin{matrix}{w}^{j} - {T}^{1} {x}^{j - 1} - {T}^{2} {x}^{j - 2} - … \\ {w}^{j + 1} - {T}^{2} {x}^{j - 1} - {T}^{3} {x}^{j - 2} - …\end{matrix} ⌋ . \qquad ( Eqn . 19 )$$

The normal equations for the least squares solution {\hat{x}^{j}, \hat{x}^{j+1}, . . . } are given by Equation 20 below:

$$⌊ \begin{matrix}{A}^{T} & ( {T}^{1} ) T \\ {O}^{T} & {A}^{T}\end{matrix} ⌋ ⌊ \begin{matrix}A & O \\ {T}^{1} & A\end{matrix} ⌋ ⌊ \begin{matrix}{x}^{j} \\ {x}^{j + 1}\end{matrix} ⌋ = ⌊ \begin{matrix}{A}^{T} & ( {T}^{1} ) T \\ {O}^{T} & {A}^{T}\end{matrix} ⌋ ⌊ \begin{matrix}{w}^{j} - {T}^{1} {x}^{j - 1} - {T}^{2} {x}^{j - 2} - … \\ {w}^{j + 1} - {T}^{2} {x}^{j - 1} - {T}^{3} {x}^{j - 2} - …\end{matrix} ⌋ . \qquad ( Eqn . 20 )$$

The decoder 125 may ignore the solution \hat{x}^{j+1} because x^{j+1} will be decoded after waveform w^{j+2} arrives, or the decoder 125 may use w^{j+2} to update the value of \hat{x}^{j+1}.

In one embodiment, Equation 20 yields relatively better results when compared with the same from Equation 17 when T¹ is “larger” than A. This is the case when the tails of the received basis pulses contain more information than the received basis pulses.

It should be understood that, however, other suitable linear algebra techniques could also be used in accordance with the present disclosure. For example, the receiver 120 may wait for any fractional number of symbols of the received waveform to solve for x^{j}, as long as the normal equations are solvable.

Solution and Pre-emphasis Using the QR Factorization

In one embodiment, the present disclosure solves the least squares problem in Equation 17 using the QR factorization of A as shown in relationship given by Equation 21 below:

A=QR. (Eqn. 21)

In Equation 21, Q is orthogonal and R is upper triangular. When the columns of A are linearly independent, this factorization gives a numerically stable operator for solving the normal equations of Equation 17 described above:

$$\begin{matrix}{\hat{x}}^{j} = {R}^{- 1} {Q}^{T} {\tilde{w}}^{j} \\ = {R}^{- 1} {Q}^{T} ( {w}^{j} - {T}^{1} {x}^{j - 1} - {T}^{2} {x}^{j - 2} - … ) \\ = {R}^{- 1} {Q}^{T} {w}^{j} - {R}^{- 1} {Q}^{T} {T}^{1} {x}^{j - 1} - {R}^{- 1} {Q}^{T} {T}^{2} {x}^{j - 2} - … . \end{matrix} \qquad ( Eqn . 22 )$$

In Equation 22, \hat{x}^{j} is the least squares solution to Equation 17.

Multiplication by orthogonal matrices is numerically stable, so the operations in Equation 22 are also numerically stable if R⁻¹ is diagonal. If the receiver 120 transmits the matrix R⁻¹ to the transmitter 105, then the transmitter 105 can pre-emphasize the basis pulses to make R⁻¹ diagonal. Suppose the transmitter 105 replaces its transmit basis pulses b^{j} with the relationship given by Equation 23 below:

C=BR⁻¹. (Eqn. 23)

In Equation 23, the columns of B are the original basis pulses, and the columns of C are the new basis pulses.

The transmitter 105 then sends messages as before using c^{j} in place of b^{j}. Equation 7 then becomes the relationship given by Equation 24 below:

$$\begin{matrix}Transmitted waveform = ⌊ \begin{matrix}{BR}^{- 1} & O & O & … \\ O & {BR}^{- 1} & O & … \\ O & O & {BR}^{- 1} & … \\ ⋮ & ⋮ & ⋮ & ⋱\end{matrix} ⌋ \\ ⌊ \begin{matrix}\begin{matrix}\begin{matrix}{x}^{1} \\ {x}^{2}\end{matrix} \\ {x}^{3}\end{matrix} \\ ⋮\end{matrix} ⌋ \\ = [ \begin{matrix}B & O & O & … \\ O & B & O & … \\ O & O & B & … \\ ⋮ & ⋮ & ⋮ & ⋱\end{matrix} ] ⌊ \begin{matrix}\begin{matrix}\begin{matrix}{R}^{- 1} {x}^{1} \\ {R}^{- 1} {x}^{2}\end{matrix} \\ {R}^{- 1} {x}^{3}\end{matrix} \\ ⋮\end{matrix} ⌋ .\end{matrix} \qquad ( Eqn . 24 )$$

The received waveform s of Equation 8 then can be shown as the relationship given by Equation 25 below:

$$\begin{matrix}Received waveform = [ \begin{matrix}A & O & O & … \\ {T}^{1} & A & O & … \\ {T}^{2} & {T}^{1} & A & … \\ ⋮ & ⋮ & ⋮ & ⋱\end{matrix} ] ⌊ \begin{matrix}\begin{matrix}\begin{matrix}{R}^{- 1} {x}^{1} \\ {R}^{- 1} {x}^{2}\end{matrix} \\ {R}^{- 1} {x}^{3}\end{matrix} \\ ⋮\end{matrix} ⌋ \\ = ⌊ \begin{matrix}{AR}^{- 1} & O & O & … \\ {T}^{1} {R}^{- 1} & {AR}^{- 1} & O & … \\ {T}^{2} {R}^{- 1} & {T}^{1} {R}^{- 1} & {AR}^{- 1} & … \\ ⋮ & ⋮ & ⋮ & ⋱\end{matrix} ⌋ ⌊ \begin{matrix}\begin{matrix}\begin{matrix}{x}^{1} \\ {x}^{2}\end{matrix} \\ {x}^{3}\end{matrix} \\ ⋮\end{matrix} ⌋ \\ = ⌊ \begin{matrix}\begin{matrix}\begin{matrix}{s}^{1} \\ {s}^{2}\end{matrix} \\ {s}^{3}\end{matrix} \\ ⋮\end{matrix} ⌋ \\ = s .\end{matrix} \qquad ( Eqn . 25 )$$

Since the QR factorization of A is given by Equation 21 as A=QR, the QR factorization for AR⁻¹ in Equation 25 is given by the relationship shown in Equation 26 below:

AR⁻¹=QRR⁻¹=Q. (Eqn. 26)

Equation 26 indicates that pre-emphasizing the transmit basis pulses results in orthogonal receive basis pulses (because the columns of Q are the receive basis pulses and Q is orthogonal). The least-squares solution operator QT is orthogonal and, therefore, numerically stable. The pre-emphasized transmit basis pulses c^{j} will not, in general, be sinusoidal even if the original transmit basis pulses b^{j} are sinusoidal.

In other embodiments, the present disclosure could pre-emphasize the transmit basis pulses based on the QR factorization of the matrix from the normal equations associated with the least squares problem.

Solution and Pre-emphasis Using the SVD Factorization

Other embodiments of the present disclosure could use the singular value decomposition (SVD) instead of the QR factorization. For example, the SVD of the matrix A is given by the relationship shown in Equation 27 below:

A=Q₁DQ₂^{T}. (Eqn. 27)

In Equation 27, Q₁ and Q₂ are orthogonal, and D is diagonal. Regardless of whether the columns of A are linearly independent, this decomposition gives a numerically stable operator for solving the normal equations of Equation 17:

\hat{x}^{j}=Q₂D^{†}Q₁^{T}\tilde{w}^{j}. (Eqn. 28)

In Equation 28, \hat{x}^{j} is the least squares solution to Equation 17, and D^{†} is the pseudo-inverse of D. If dᵢ is the i^{th} diagonal element of D, then the i^{th} diagonal element of D^{†} is given by the relationship shown in Equation 29 below:

$${d}_{i}^{†} = \{ \begin{matrix}1 / {d}_{i} & if & {d}_{i} \neq 0 , \\ 0 & if & {d}_{i} = 0.\end{matrix} \qquad ( Eqn . 29 )$$

In one embodiment, it could be helpful to replace Equation 29 with the relationship shown in Equation 30 below:

$${d}_{i}^{†} = \{ \begin{matrix}1 / {d}_{i} & if & {d}_{i} is “ large ” , \\ 0 & if & {d}_{i} is “ small ” .\end{matrix} \qquad ( Eqn . 30 )$$

In Equation 30, “large” and “small” are chosen wisely. Equation 30 separates the viable carriers (those with “large” dᵢ) from non-viable carriers (those with “small” dᵢ, which are indistinguishable from noise)

If the receiver 120 transmits the matrix Q₂D^{†} to the transmitter 105, then the transmitter 105 can pre-emphasize the basis pulses. Suppose, for example, that the transmitter 105 replaces b^{j} with the relationship shown in Equation 31 below:

C=BQ₂D^{†}. (Eqn. 31)

In Equation 31, the columns of B are the original basis pulses, and the columns of C are the new basis pulses.

The transmitter 105 then sends messages as before using c^{j} in place of b^{j}, and Equation 7 then becomes the relationship shown in Equation 32 below:

$$\begin{matrix}Transmitted waveform = [ \begin{matrix}{BQ}_{2} {D}^{†} & O & O & … \\ O & {BQ}_{2} {D}^{†} & O & … \\ O & O & {BQ}_{2} {D}^{†} & … \\ ⋮ & ⋮ & ⋮ & ⋱\end{matrix} ] [ \begin{matrix}\begin{matrix}\begin{matrix}{x}^{1} \\ {x}^{2}\end{matrix} \\ {x}^{3}\end{matrix} \\ ⋮\end{matrix} ] \\ = [ \begin{matrix}B & O & O & … \\ O & B & O & … \\ O & O & B & … \\ ⋮ & ⋮ & ⋮ & ⋱\end{matrix} ] [ \begin{matrix}\begin{matrix}\begin{matrix}{Q}_{2} {D}^{†} {x}^{1} \\ {Q}_{2} {D}^{†} {x}^{2}\end{matrix} \\ {Q}_{2} {D}^{†} {x}^{3}\end{matrix} \\ ⋮\end{matrix} ] .\end{matrix} \qquad ( Eqn . 32 )$$

The received waveform s of Equation 8 then could be shown as the relationship given in Equation 33 below:

$$\begin{matrix}Received waveform = [ \begin{matrix}A & O & O & … \\ {T}^{1} & A & O & … \\ {T}^{2} & {T}^{1} & A & … \\ ⋮ & ⋮ & ⋮ & ⋱\end{matrix} ] [ \begin{matrix}\begin{matrix}\begin{matrix}{Q}_{2} {D}^{†} {x}^{1} \\ {Q}_{2} {D}^{†} {x}^{2}\end{matrix} \\ {Q}_{2} {D}^{†} {x}^{3}\end{matrix} \\ ⋮\end{matrix} ] \\ = [ \begin{matrix}{AQ}_{2} {D}^{†} & O & O & … \\ {T}^{1} {Q}_{2} {D}^{†} & {AQ}_{2} {D}^{†} & O & … \\ {T}^{2} {Q}_{2} {D}^{†} & {T}^{1} {Q}_{2} {D}^{†} & {AQ}_{2} {D}^{†} & … \\ ⋮ & ⋮ & ⋮ & ⋱\end{matrix} ] [ \begin{matrix}\begin{matrix}\begin{matrix}{x}^{1} \\ {x}^{2}\end{matrix} \\ {x}^{3}\end{matrix} \\ ⋮\end{matrix} ] \\ = [ \begin{matrix}\begin{matrix}\begin{matrix}{s}^{1} \\ {s}^{2}\end{matrix} \\ {s}^{3}\end{matrix} \\ ⋮\end{matrix} ] \\ = s .\end{matrix} \qquad ( Eqn . 33 )$$

Since the SVD of A is given by Equation 27 as A=Q₁DQ₂^{T}, the SVD of AD^{†}Q₁^{T} in Equation 25 is given by the relationship shown in Equation 35 below:

AQ₂D^{†}=Q₁DQ₂^{T}Q₂D^{†}=Q₁DD^{†}=\tilde{Q}₁. (Eqn. 34)

In Equation 34, \tilde{Q}₁ includes those columns of Q₁ associated with the “large” diagonal elements of D, and zero in the columns of Q₁ associated with the “small” diagonal elements of D. Pre-emphasis of the transmit basis pulses results in orthogonal receive basis pulses, improving the numerical properties of the solution operator. It also defines which basis pulses are viable.

In one embodiment, the present disclosure provides an advantage of using the SVD to pre-emphasize the basis pulses in that, if the original transmit basis pulses b^{j} are orthogonal, both the pre-emphasized transmit basis pulses c^{j} and the receive basis pulses are orthogonal. To see that the c^{j} are orthogonal, let C be the matrix with columns c^{j} of the “viable” basis pulses. Then, if B is orthogonal, the relationship given by Equation 35 below is diagonal.

C^{T}C=(BQ₂D^{†})^{T}BQ₂D^{†}=D^{†}^{^{T}}Q₂^{T}B^{T}BQ₂D^{†}=D^{†}^{^{T}}D^{†}. (Eqn. 35)

In Equation 35, the columns of C are orthogonal. In other words, the receive basis pulses are the columns of Q₁ and are, therefore, orthogonal.

It should be understood, however, that other suitable linear algebra techniques and relationships could also be used in accordance with the present disclosure. It should also be understood that the pre-emphasized transmit basis pulses c^{j} will not, in general, be sinusoidal even if the original transmit basis pulses bⁱ are sinusoidal.

Performance with Noisy Communications

Noise on communication lines is often modeled as Gaussian white noise (GWN). If n is the noise in Equation 9, then the inverse-filtered waveform is given by the relationship shown in Equation 36 below:

Fw=F(s+n)=Fs+Fn. (Eqn. 36)

The term Fₛ contains all of the information about the messages x^{j}. The term Fₙ is noise but is not, in general, GWN even if n is Gaussian white noise. Filtering the received waveform w generally produces a noise term Fn which degrades the precision of decoding more than the original noise n.

In one embodiment, the present disclosure does not filter the waveform w and, therefore, does not filter the noise n. For example, the least squares solution to Equation 10 minimizes errors due to GWN. In the language of statistics, the least squares solution operator has the smallest variance (and, therefore, is the least affected by noise) among all linear, unbiased solution operators, provided the noise is GWN.

Other embodiments of the present disclosure choose solution operators based on error-minimizing techniques which are the best performers in their class based on the properties of the line noise n. These techniques include, for example, techniques using weighted least squares.

Resource Requirements

Embodiments of the present disclosure generally require fewer resources to implement than conventional QAM decoders. The decoders of the present disclosure could filter the receive waveform and perform Fourier analysis on the filtered waveform. However, the inverse filter F must be as long as the receive basis pulses in order to be effective.

If, for example, there are l tail matrices T^{j}, the length of the inverse filter must be on the order of h=(1+l)m, where m is the symbol length. Computing Fw^{j} as in Equation 8, therefore, requires hm=(1+l)m² multiplications. Decoding the message by multiplying by B^{T} as in Equation 37 below:

B^{T}B=I, the n×n identity matrix. (Eqn. 37)

In Equation 37, B^{T} is the transpose of B. Equation 37 requires nm more multiplications for a total of (1+l)m²+nm multiplications. If the b^{j} are orthogonal sinusoids, then the Fast Fourier Transform may reduce the number of multiplications to

$$\frac{1}{2} m {log}_{2} ( n ) .$$

By contrast, computing \tilde{w}^{j} in Equation 16 requires lmn multiplications. Decoding the message \hat{x}^{j} using the solution operator R⁻¹Q^{T} in Equation 22 requires an additional nm multiplications. Implementing the top line of Equation 22, therefore, requires the relationship shown in Equation 38 below using fewer multiplications than a comparable implementation of a conventional QAM decoder:

((1+l)m²+nm)−(lmn+nm)=m²+lm(m−n). (Eqn. 38)

Since m must be greater than n (and m is often significantly greater than n), the number of multiplications is smaller for the embodiment of this disclosure than for conventional QAM decoding.

Further savings of resources are obtained over conventional QAM decoders by, for example, implementing the relationship found in the bottom line of Equation 22. Each of the corrections R⁻¹Q^{T}Tⁱx^{j-i} requires n² multiplications, and the total correction, therefore, requires ln² multiplications. The remaining product R⁻¹Q^{T}w^{j} requires nm multiplications. Implementing the bottom line of Equation 22, therefore, requires the relationship shown in Equation 39 below using fewer multiplications than a comparable implementation of conventional QAM decoders. This savings is even greater than that presented in Equation 38.

((1+l)m²+nm)−(ln²+nm)=m²+l(m+n)(m−n), fewer multiplications. (Eqn. 39)

Other embodiments of the present disclosure could also require fewer multiplications than a comparable conventional QAM decoder. In addition, although the above techniques included using linear relationships, it should be understood that other techniques using non-linear relationships could also be used in accordance with the present disclosure.

Embodiments of the present disclosure could be used in a variety of different applications. In one embodiment, a AM decoder of the present disclosure could be used in any suitable communication device and equipment such as, for example, digital subscriber line (DSL) modems.

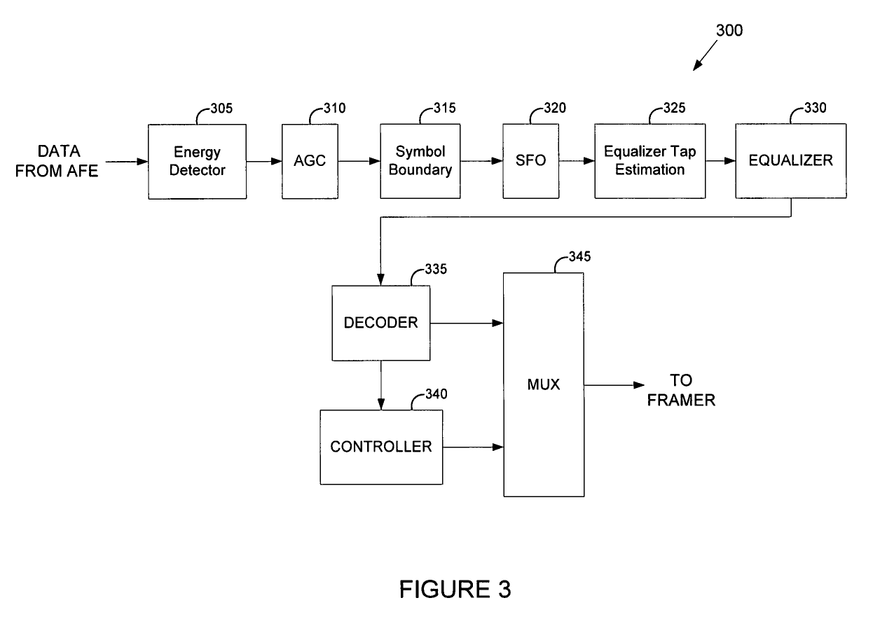

FIG. 3 is a diagram of a DSL modem 300 using a QAM decoder 335 within a receiver, such as the receiver 120 (where the decoder 335 would be shown as decoder 125), in accordance with one embodiment of the present disclosure. Modem 300 is for illustration purposes only. It should be understood that other modems could also be used in accordance with the present disclosure.

In modem 300, analog waveform from an analog front end (AFE) is received and detected using an energy detector module 305. Energy detector module 305 passes the data to an automatic gain control (AGC) module 310. AGC module 310 passes data to a symbol boundary module 315. After passing through symbol boundary module 315, the modified signal is then passed through a signal frequency offset (SFO) module 320 and then to an equalizer tap estimation module 325.

After passing through equalizer tap estimation module 325, the signal is then passed to an equalizer 330 to fine tune the baseband signal levels. The decoder 335 operates on or decodes messages in accordance with the methods and processes described herein. Equalizer 330 then passes the signals to decoder 335 (e.g. decoder 125). The recovered messages from decoder 335 are then passed to a multiplexer (MUX) 345 along with any control signals from a controller 340. MUX 345 then passes along related information to the framer.

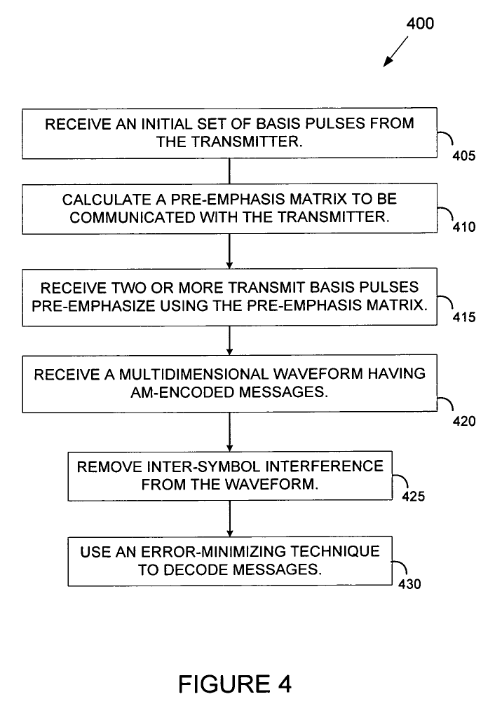

Accordingly, in one embodiment, the present disclosure provides, for example, a method 400 (shown in FIG. 4). In this embodiment, a receiver receives an initial set of basis pulses transmitted from the transmitter in step 405. The receiver then calculates a pre-emphasis matrix based the initial set of basis pulses and transmits the pre-emphasis matrix to the transmitter in step 410. The transmitted pre-emphasis matrix is used by the transmitter to pre-emphasize the transmit basis pulses of a multi-dimensional waveform having AM-encoded messages. The transmit basis pulse may be pre-emphasized, for example, using QR factorization or singular value decomposition (SVD). In step 415, the receiver receives from the transmitter two or more transmit pulses pre-emphasized using the pre-emphasis matrix. The receiver then receives the multi-dimensional waveform having AM-encoded messages from the transmitter in step 420. Upon receiving the waveform, the receiver removes inter-symbol interference from the waveform in step 425. In step 430, the receiver decodes the messages using an error-minimizing technique. The error-minimizing technique may be, for example, a least-squares technique.

Accordingly, embodiments of the present disclosure provide improved decoders and methods for decoding messages encoded with AM techniques.

It may be advantageous to set forth definitions of certain words and phrases used in this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method of decoding amplitude modulation (AM)-encoded messages, the method comprising:
generating a received waveform matrix from a series of receive basis pulses;
receiving a multi-dimensional waveform having n AM-encoded messages;
removing inter-symbol interference from the waveform; and
applying an error-minimizing technique to the received waveform matrix to decode the n AM-encoded messages.

2. The method of claim 1, wherein amplitude modulation comprises quadrature amplitude modulation (QAM).

3. The method of claim 1, wherein removing the inter-symbol interference from the waveform produces tail-less messages.

4. The method of claim 1, wherein the error-minimizing technique comprises a least-squares technique.

5. The method of claim 1, wherein decoding the messages occurs before the entire waveform is received.

6. The method of claim 1, wherein two or more transmit basis pulses of the waveform are pre-emphasized.

7. The method of claim 1, wherein two or more transmit basis pulses of the waveform are pre-emphasized using the following relationship: C=BR⁻¹,
wherein B denotes the original basis pulses, C denotes the transmit basis pulses, and R denotes upper triangular.

8. The method of claim 1, wherein the two or more transmit basis pulses of the waveform are pre-emphasized using a QR factorization or a singular value decomposition (SVD).

9. The method of claim 1, wherein the two or more transmit basis pulses of the waveform are pre-emphasized using the following relationship: C=BQ₂D^{†},
wherein B denotes the original basis pulses, C denotes the transmit basis pulses, D^{†} denotes the pseudo-inverse of diagonal D, and Q₂ denotes orthogonal.

10. A receiver for decoding amplitude modulation (AM)-encoded messages, the receiver comprising:
an input for receiving a multi-dimensional waveform having n AM-encoded messages; and
a decoder for removing inter-symbol interference from the waveform;
wherein the decoder applies an error-minimizing technique to a received waveform matrix to decode the n messages after removing the inter-symbol interference from the waveform, the received waveform matrix is generated from a series of receive basis pulses received from a transmitter.

11. The receiver of claim 10, wherein amplitude modulation comprises quadrature amplitude modulation (QAM).

12. The receiver of claim 10, wherein removing the inter-symbol interference from the waveform produces tail-less messages.

13. The receiver of claim 10, wherein the error-minimizing technique comprises a least-squares technique.

14. The receiver of claim 10, wherein the decoder uses the error-minimizing technique to decode messages before the entire waveform is received.

15. The receiver of claim 10, wherein two or more transmit basis pulses of the waveform are pre-emphasized.

16. The receiver of claim 10, wherein the two or more transmit basis pulses of the waveform are pre-emphasized using the following relationship: C=BR⁻¹,
wherein B denotes the original basis pulses, C denotes the transmit basis pulses, and R denotes upper triangular.

17. The receiver of claim 10, wherein the two or more transmit basis pulses of the waveform are pre-emphasized using a QR factorization or a singular value decomposition (SVD).

18. The receiver of claim 10, wherein the two or more transmit basis pulses of the waveform are pre-emphasized using the following relationship: C=BQ₂D^{†},
wherein B denotes the original basis pulses, C denotes the transmit basis pulses, D^{†} denotes the pseudo-inverse of diagonal D, and Q₂ denotes orthogonal.

19. A method of decoding amplitude modulation (AM)-encoded messages, the method comprising:
receiving a series of basis pulses from a transmitter;
transmitting a pre-emphasis matrix based on the series of basis pulses to the transmitter;
receiving, from the transmitter, a multi-dimensional waveform having n AM-encoded messages, wherein two or more transmit basis pulses of the waveform are pre-emphasized using the pre-emphasis matrix;
removing inter-symbol interference from the waveform; and
using an error-minimizing technique to decode the n AM-encoded messages after removing the inter-symbol interference from the waveform.

20. The method of claim 19, wherein amplitude modulation comprises quadrature amplitude modulation (QAM).
